(19) United States
(12) Patent Application Publication
(10) Pub. No.: US 2003/0192830 A1
(43) Pub. Date: Oct. 16, 2003

(54) Apparatus and method for removal of impurities from hydrocarbon fuels

(76) Inventors: Bryan S. Memmott, Martinsburg, WV (US); Robert E. Davis, Hinsdale, IL (US)

Correspondence Address: GODFREY & KAHN S.C., 780 NORTH WATER STREET, MILWAUKEE, WI, 53202, US

(21) Appl. No.: 10/119,969

(22) Filed: Apr. 10, 2002

(51) Int. Cl. B01D 15/00

(52) U.S. Cl. 210/663

(57) ABSTRACT

A filter and a method of using the filter for removing contaminants from liquid propane gas. The liquid propane gas enters the filter through an inlet and passes through a first filtration element where chemical contaminants are removed by a molecular sieving agent. The molecular sieving agent may be a zeolite. Subsequently, the liquid propane gas passes through a second filtration element where particulate contaminants are removed. The invention is also a method of removing contaminants from liquid propane gas including the step of routing the flow of the liquid propane gas through chemical and particulate filter elements so that chemical and particulate contaminants are sequentially removed.

### FIELD OF THE INVENTION

The present invention relates generally to an apparatus and method for removing impurities from hydrocarbon fuels. More specifically, this invention relates to a filter containing a molecular sieving agent and a method of using the filter to remove contaminants from liquid propane gas.

### BACKGROUND OF THE INVENTION

Propane gas is a well known and extremely valuable fuel source in our present day economy. Commercial uses of propane gas are varied and range from powering forklift truck engines to providing the heating requirements for steel mills. Indeed, propane gas has been recognized as a convenient and economical fuel for a myriad of industrial applications.

However, energy sources, especially hydrocarbon-based fuels, have recently come under increased scrutiny spurred by concerns over environmental pollution and workplace safety. Many fuel sources have had tighter restrictions placed on their contaminant content. For example, contaminant sulfur compounds present in diesel fuels, known to be major contributors to air pollution, have been targeted by the Federal government for dramatic reduction in the near future. As well, propane gas has been evaluated and certain requirements have been suggested for improving its qualities and characteristics to move toward a more environmental and workplace-friendly energy source.

Traditionally, propane gas for use in commercial applications has been obtained by one of two approaches: (1) propane gas may be obtained as a constituent of crude oil through petroleum refining processes; and (2) propane gas has been produced by “cracking” hydrocarbons of greater chain length in various chemical processes. Propane gas obtained by either methodology may then be stored, shipped and supplied to an end use in the gaseous state, or as will be described below, in a pressurized form known as liquid propane gas (LPG). LPG provides a convenient and economical approach to handling and transporting propane.

Various end use applications utilize propane vapor drawn from an LPG storage tank. A vapor withdrawal system facilitates this process by drawing the heat necessary to vaporize the LPG from contact with the bulk tank itself. In turn, the bulk tank may draw heat from the surrounding ambient air. Two variables are recognized which affect the rate of vaporization: (1) as the LPG level falls in the tank, the rate of vaporization lowers due to the loss of contact between the LPG and the tank; and (2) the rate of vaporization is lowered when the temperature of the ambient air surrounding the tank is low.

Although the vapor withdrawal system described above is adequate where a large LPG storage tank is involved, certain LPG applications utilizing small LPG storage tanks require a different configuration to provide adequate propane vaporization. For example, on a mobile engine application such as a fork lift, only 30-35 lbs. of LPG is carried in a storage tank. The small tank size and small volume of LPG combine to provide insufficient propane vaporization at the tank to maintain proper engine performance.

To solve the above-described problem, a vaporizer regulator is set apart from the tank and allows the LPG to draw the necessary heat to vaporize effectively. Unfortunately, vaporizer regulators have long been known to suffer from residue buildup due to contaminants contained within the LPG depositing on the interior surfaces of the regulator. This buildup is especially troublesome where the LPG was originally obtained through chemical “cracking” processes which inherently leave low levels of unreacted reagent and reaction side products in the major propane gas product. Contaminants may further include additives, surfactants, or surface acting agents. Residue buildup is not limited to the regulator but commonly occurs in downstream system components including, but not limited to, fuel injectors and air/gas mixers. Residue buildup ultimately results in engine starting difficulties and inconsistent engine performance in as few as 500 hours of system operation. Disassembly of the system is required and the generally sticky, or gummy, residues built up on the interior surfaces of the regulator must be thoroughly removed. Five hundred hours of system operation is considered sub-optimal and an industry standard of 5000 hours is being presently considered by the Environmental Protection Agency (EPA) as a minimum durability standard.

Several solutions to the residue buildup problem are available but none offer a convenient, cost-effective and reliable answer. For instance, a frequent regimen of regulator service including a total dismantling of the regulator is labor intensive and leads to tremendous downtime for devices requiring such regular maintenance. Alternatively, regulators have been equipped with thermostats and heating/cooling combinations in an attempt to discourage residues from depositing on the sensitive interiors of the regulators. However, contaminants may still deposit in components of the engine system downstream of the regulator such as the air intake manifold and on the engine intake valve itself. Thus, this approach has limited applicability.

As well, chemical additives have been provided in the LPG to dissolve the residue in the regulator and pass it on through the engine. Such approach is clearly undesirable due to the presence of additional chemicals which may pose environmental and workplace hazards after passing through the engine. Exhaust emissions aside, it is unclear that current additives are effective in dissolving the major contaminants in LPG and additives also raise fuel handling issues regarding treated versus untreated LPG.

In light of the above described problem, it is desirable to have an apparatus and method by which the contaminants present in LPG may be effectively reduced or removed.

### SUMMARY OF THE INVENTION

Therefore, in view of the problems associated with the previously described solutions, it is an object of the present invention to provide an apparatus and method by which the contaminants present in LPG may be effectively reduced or removed.

In a preferred embodiment, a filter according to the invention will include an upper housing equipped with an inlet. The inlet is capable of receiving LPG from upstream of the filter. The upper housing also includes an outlet capable of conveying LPG downstream of the filter. A lower housing is removably attached to the upper housing and communicates with the inlet. An inner assembly having first and second ends is removably attached to the upper housing and further communicates at its first end with the outlet. The inner assembly is disposed within and spaced apart from the outer housing and the two elements define a space termed the “first filtration zone.” The inner assembly itself further defines a second space termed the “second filtration zone.”

The inner assembly may further include a cylinder at the boundary between the first and second filtration zones. This cylinder may partially enclose the second filter element and have a plurality of perforations allowing flow of LPG between the first and second filtration zones.

A filter according to the invention further includes a first filter element removably positioned between the outer housing and the inner assembly in the first filtration zone. The first filter element is comprised by an LPG permeable enclosure enclosing a molecular sieving agent such as a zeolite or an activated carbon. The LPG permeable enclosure may comprise a cellulose-based material or a metallic mesh. The enclosure may completely surround the molecular sieving agent or provide only partial enclosure of the agent. A second filter element is removably contained within the second filtration zone and includes a porous filtration material through which LPG can flow but particulate material may be entrapped. The first and second filter elements are constructed and arranged such that the respective elements may communicate with each other at a boundary between the first and second filtration zones.

A filter according to the present invention may further include a sensor in communication with LPG at the outlet for indicating the contaminant level of LPG exiting the filter.

The present invention also includes a method for removing contaminants from LPG. The method includes the step of selecting a filter including a first filter element comprised by a molecular sieving agent for initially removing chemical contaminants from the LPG. A second filter element is also selected for subsequently removing particulate contaminants from the LPG. As selected, the first filter element includes a molecular sieving agent such as a zeolite or activated carbon and the second filter element is capable of entrapping particulate matter contained within the LPG.

The method according to the invention further includes the step of routing a flow of LPG through the filter so that chemical contaminants and particulate contaminants are sequentially removed from the liquid propane gas.

The method may include the further step of monitoring the LPG exiting the filter to determine the level of contaminants remaining in the LPG.

Various other features, objects, and advantages of the invention will be made apparent to those skilled in the art from the accompanying drawings and detailed description thereof.

### BRIEF DESCRIPTION OF THE DRAWINGS

The previously stated features and advantages of the present invention will be apparent from the following detailed description as illustrated in the accompanying drawings wherein like reference numerals throughout the various figures denote like structural elements, and in which:

FIG. 1 is a general schematic showing a filter according to the invention positioned downstream of an LPG storage tank on a device, such as a fork lift, and upstream of a converter, or regulator, providing propane gas to an end application such as an engine;

FIG. 2 is a general schematic showing a filter according to the invention placed downstream of a bulk fuel tank and upstream of an LPG dispensing station;

FIG. 3 is a general schematic showing a filter according to the invention placed downstream of a bulk LPG storage tank and upstream of a regulator/vaporizer which supplies propane gas to a plant apparatus;

FIG. 4 is cross-sectional view of a preferred embodiment of a filter according to the present invention;

FIG. 5 is a cross-sectional view of a second embodiment of a filter according to the present invention;

FIG. 6 is a side plan view of a cylinder to partially enclose the second filter element having a plurality of perforations through which LPG may flow;

FIG. 7 is data obtained from FT-IR spectroscopic analysis of residue from the interior of an LPG regulator;

FIG. 8 is data obtained from FT-IR spectroscopic analysis of residue from the inside of an LPG storage tank;

FIG. 9 is data obtained from FT-IR spectroscopic analysis of a residue film formed on a diaphragm;

FIG. 10 is data obtained from FT-IR spectroscopic analysis of an LPG sample, prefiltered, described in Example 2;

FIG. 11 is data obtained from FT-IR spectroscopic analysis of an LPG sample described in Example 2, after 10 gallons of LPG flow through a filter according to the invention;

FIG. 12 is data obtained from FT-IR spectroscopic analysis of an LPG sample described in Example 2 after 100 gallons of the LPG flow through a filter according to the invention; and

FIG. 13 is data obtained from FT-IR spectroscopic analysis of an LPG sample described in Example 2, after 500 gallons of LPG flow through a filter according to the invention.

### DETAILED DESCRIPTION OF THE INVENTION

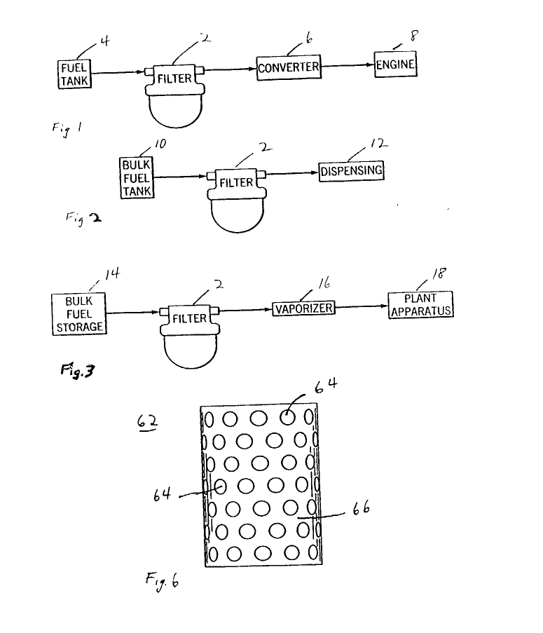

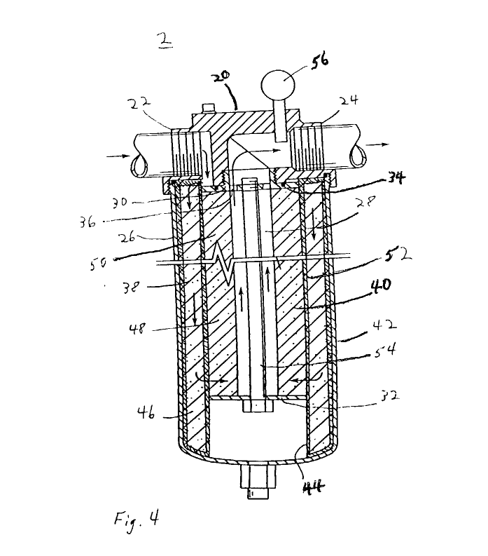

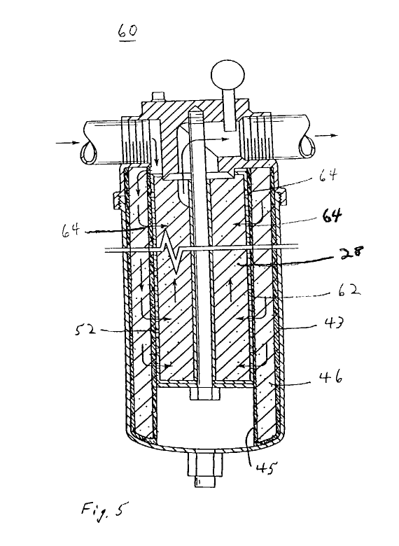

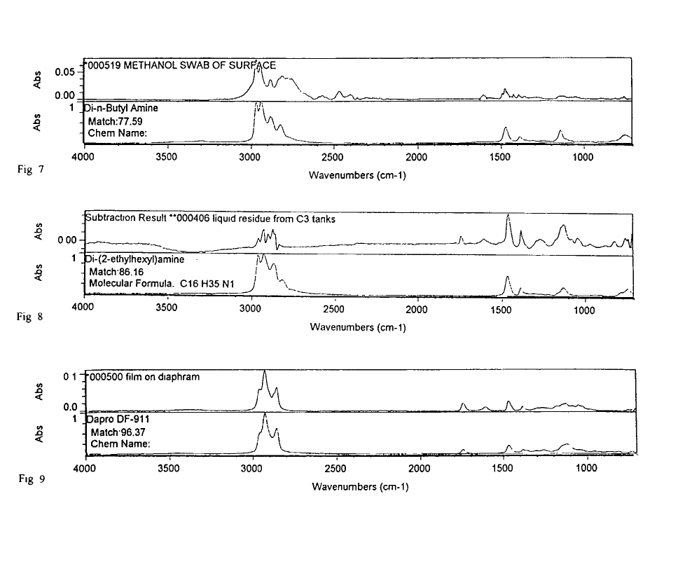

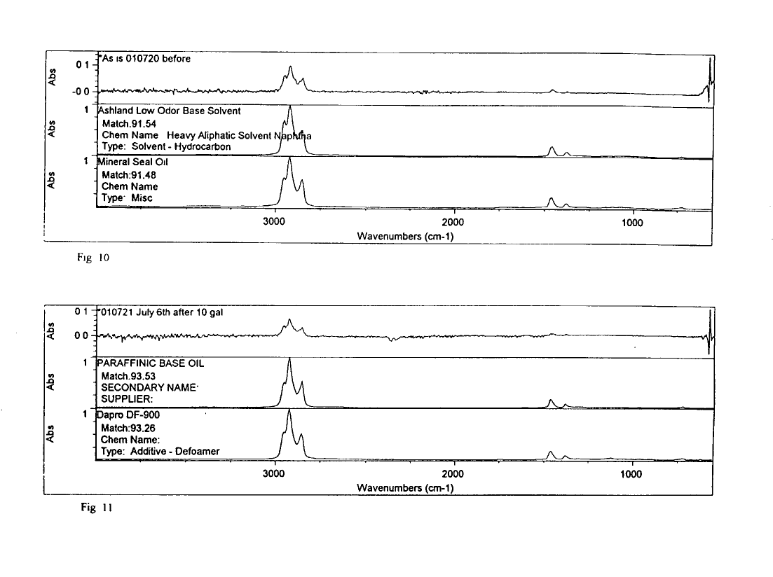

The present invention is a filter and method of using the filter applicable to a variety of industrial settings where LPG is handled or consumed as an energy source. As shown in FIG. 1, a filter 2 according to the invention is positioned downstream of an LPG storage tank 4, and upstream of a converter 6, or regulator, providing propane gas to an end application such as an engine 8. FIG. 1 is illustrative of the LPG system on a mobile device, such as a fork lift. An alternative arrangement is shown in FIG. 2 where filter 2 is used to remove contaminants from LPG in an in-line arrangement where filter 2 is placed downstream of a bulk LPG storage tank 10 and upstream of an LPG dispensing station 12. In yet another embodiment, FIG. 3 shows filter 2 placed downstream of a bulk LPG storage tank 14 and upstream of a regulator/vaporizer 16 which supplies propane gas to a plant apparatus 18. All of these particular applications, and others, are certainly within the scope of use for the present invention.

Referring now to FIG. 4, a preferred embodiment of a filter 2 according to the invention is shown. Filter 2 includes an upper housing 20 including an inlet 22 capable of receiving LPG from upstream of filter 2. Upper housing 20 also includes an outlet 24 capable of conveying LPG downstream of filter 2 after the LPG has passed through filter 2. Upper housing 20 may be secured in an in-line arrangement by any technique known in the field, including threads as shown in FIG. 4.

A lower housing 26 is removably attached to upper housing 20. Lower housing 26 communicates with inlet 22 and may be secured to upper housing 20 by any suitable technique known in the field, including threads as shown in FIG. 4, reminiscent of a replaceable screw-on engine oil filter.

Filter 2 further contains an inner assembly 28 which includes first and second ends, 30, 32, respectively. Inner assembly 28 is removably attached to the upper housing 20 at first end 30 by threads or other equivalent means known in the field. A sealing ring 34 may be further included on first end 30 to ensure LPG does not leak between inlet 22 and outlet 24. Inner assembly 28 further communicates at first end 30 with outlet 24 so that LPG may flow through, in general, first end 30 to outlet 24. First end 30 further includes apertures 36 to effectuate this flow of LPG.

Inner assembly 28 is disposed within and spaced apart from outer housing 26 thereby defining a first filtration zone 38, which physically comprises the zone between the outer housing 26 and the inner assembly 28. Construction of the filter is such that LPG may enter inlet 22 and follow an unimpeded flow into first filtration zone 38. Inner assembly 28 further defines a second filtration zone 40 within the space between first end 30 and second end 32.

Still referring to FIG. 4, a first filter element 42 is removably positioned between outer housing 26 and inner assembly 28 so that first filtration zone 40 is substantially filled by first filter element 42. First filter element 42 is constructed of an LPG permeable enclosure 44 enclosing a molecular sieving agent 46. LPG permeable enclosure 44 may be formed from LPG-resistant porous paper, cardboard, fabric, plastic or a metallic mesh. Enclosure 44 is preferably formed from a brass metallic mesh. Brass mesh is shown to be useful in Example 2 below. Materials suitable for construction of LPG permeable enclosure 44 should have a minimum porosity at least adequate to prevent molecular sieving agent 46 from escaping to the outside of LPG permeable enclosure 44. In a preferred embodiment, enclosure 44 completely surrounds molecular sieving agent 46, as shown in FIG. 5. However, it is within the scope of the invention for enclosure 44 to only partially surround molecular sieving agent 46 such that enclosure 44 may, at a minimum, provide only a barrier between agent 46 and inner assembly 28. In the most minimal case, enclosure 44 would be a sleeve surrounding inner assembly 28 and molecular sieving agent 46 would occupy the space between enclosure 44 and the wall of lower housing 26.

Molecular sieving agent 46 is a porous material and is herein broadly defined as including microporous structure composed of either crystalline aluminosilicates, chemically similar to clays and feldspars and commonly termed zeolites, or crystalline aluminophosphates derived from mixtures containing an organic amine or quaternary ammonium salt. Aluminum-magnesium silicates, commonly termed attapulgite clays, are further illustrative of such materials useful in the present invention. Pore sizes for the above materials may vary considerably with 5 to 10 angstroms being common pore sizes. The outstanding characteristic of these materials is their ability to undergo dehydration with little or no change in crystalline structure. The dehydrated crystals are interlaced with regularly spaced channels of molecular dimensions, which can comprise 50% of the total volume of the crystals. The empty cavities in activated molecular sieve crystals have a strong tendency to recapture the water molecules that have been driven off by activation processes. This tendency is so strong that if no water is present they will accept any material that can get into the cavity. However, only those molecules that are small enough to pass through the pores of the crystals can enter the cavities and be entrapped, absorbed or adsorbed on the interior surfaces.

In addition to the above described molecular sieving agents, other suitable agents having microporous structure useful in entrapping, absorbing or adsorbing chemical contaminants include activated carbons or charcoals. Activated carbons and charcoals are herein broadly defined as amorphous forms of carbon characterized by high adsorptivity for many gases, vapors, and colloidal solids. Such carbons are obtained by the destructive distillation of wood, nut shells, animal bones, or other carbonaceous material. Activation may be by heating with steam or carbon dioxide resulting in a porous “honey comb” internal structure.

As can be appreciated from the foregoing, characteristic of all agents useful with the invention is the ability to entrap, absorb or adsorb small molecules into or onto a porous environment. Suitable materials have the ability to entrap, absorb or adsorb small molecules such as, for example, CO₂, NH₃, ethanol, and ethyl amine. Small amines are common chemical contaminants of LPG as Example 1 below demonstrates. These contaminant molecules are meant to be illustrative and in no way inclusive of all chemical contaminants handled by the present invention. Such small molecules may enter cavities within the sieving agent 46 and become entrapped absorbed, or absorbed, whereas larger molecules, such as branched chain hydrocarbons, cannot enter the porous structure and flow through sieving agent 46.

Zeolites are particularly attractive sieving agents for use in the present invention because, although zeolites do occur naturally, they may also be synthesized to exacting porosity requirements. Zeolites are therefore the preferred sieving agent for use herein. Uniform porosity may facilitate selective removal of molecules up to a specific three dimensional size. The porosity of a zeolite useful in the invention will be in the range of about 2 to 100 angstroms, with 4 to 20 angstroms preferred and 10 angstroms most preferred. A suitable zeolite is available from W. R. Grace and Company under the tradename Formed Molecular Sieve having an average porosity of 10 angstroms. Although chemical contaminants are described above as being entrapped, absorbed or adsorbed onto a sieving agent, no single theory of operation is adopted or claimed herein.

Inner assembly 28 includes and supports a second filter element 48 which is removably positioned within second filtration zone 40 and is comprised by a porous filtration material 50 wherein the first and second filter elements 42, 48, respectively, communicate with each other at a boundary 52 between the first and second filtration zones 38, 40. Porous filtration material 50 will have a porosity in the range of about 5-50 microns and may be formed from a material such as paper, cardboard, plastic or metal in the form of a mesh. Paper is preferred. Porous filtration material 50 may be shaped in any manner known in the field to provide increased surface area for contact with LPG (e.g., corrugated paper). First end 30 and second end 32 of inner assembly 28 are structured to support second filter element 48. Second filter element 48 may be secured within inner assembly 28 by a fastening assembly 54 passing through second end 32 and second filter element 28 to be accepted by first end 30 (shown in FIG. 4) or upper housing 20 (alternatively shown in FIG. 5).

FIG. 4 also shows that filter 2 may include a sensor 56 in communication with exiting LPG at the outlet 24 for indicating a measurable quality of LPG exiting outlet 24. Sensor 56 may be of several varieties, although a preferred sensor will provide data regarding the level of chemical and particulate contaminants remaining in filtered LPG. However, sensor 56 may also be of simple design known in the field for simply monitoring LPG flow rate and/or volume of LPG pumped. A complex sensor for monitoring chemical/particulate contaminants may be achieved with a sensor arrangement including analytical instrumentation having an infrared, UV-visible, or atomic absorption spectroscopy component for sample analysis. Many such suitable sensor arrangements may be envisioned and are well known in the field.

Now referring to FIG. 5, a second embodiment filter 60 according to the invention is shown wherein inner assembly 28 includes a cylinder 62 at the boundary 52 between the first and second filtration zones, 38, 40. Cylinder 62 partially encloses second filter element 48 and has a plurality of perforations 64 which allow LPG to flow between the first and second filtration zones, 38, 40 respectively. As shown in FIG. 5, cylinder 62, may itself be supported by the first end 30 and second end 32 of inner assembly 28.

FIG. 5 further illustrates a first filter element 43 having an LPG permeable enclosure 45 incompletely enclosing molecular sieving agent 46. It can be observed that, in this second embodiment, LPG permeable enclosure 45 is not closed at the region immediately adjacent to upper housing 20. An enclosure 45 of this design is particularly useful where the user desires the ability to discard exhausted molecular sieving agent and replace it with fresh agent while repeatedly utilizing the same enclosure 45. Where an enclosure 45 does not completely enclose an agent 46, construction may be of metallic mesh to promote structural stability.

FIG. 6 shows a side plan view of cylinder 62 having a plurality of perforations 64 formed in a wall 66. It is intended that cylinder 62 may be optionally included in the invention where a longer contact time between LPG and the molecular sieving agent is required. Furthermore, the size and number of perforations 64 in cylinder 62 may be varied to achieve an optimal LPG flow rate versus chemical contaminant level. Optional use of cylinder 62 provides flexibility of use and allows the user to tailor the filter and method to a particular application. Factors influencing the use of cylinder 62 and its particular configuration may include, but are not limited to,.pore size of molecular sieving agent used, LPG flow pressure and flow rate, and desired minimum/maximum contaminant level permissible.

Filters constructed according to the invention are intended to operate under the high pressures which LPG is stored, handled and dispensed. In particular, it is desirable that a filter be capable of operating at inlet pressures as required by applicable Underwriter's Laboratory (UL) standards, National Fire Protection Association (NFPA) standards (e.g., NFPA Standard No. 58), and other regulatory agencies, U.S. or foreign, known to exert authority over devices in the present field. Construction of upper housing 20, lower housing 26, inner assembly 28 and cylinder 62 is preferably of die cast aluminum. Die cast aluminum is especially preferred where weight of a filter is of concern, such as on a fork lift. However, construction of the above-noted elements based on steel, brass, or equivalent alloys is also possible.

It should be further noted that relative size and configuration of a filter according to the invention may vary widely as the filter and method disclosed herein are intended to have use in and on a wide variety of applications. The particular embodiments discussed above are particularly well-suited for use on mobile equipment, such as fork lifts. However, the invention also encompasses filters finding alternative use. As exemplified by FIGS. 1-3, the invention may find use at a bulk LPG dispensing plant, an LPG production facility, an LPG retail storage tank site, or similar operation.

The basic method of practicing the present invention will now be described. A user will first select a filter 2 according to the invention described herein where the filter 2 includes a first filter element 42 including a molecular sieving agent 46. First filter element 42 is selected to initially remove chemical contaminants from LPG. Such filter will also include a second filter element 48 for subsequently removing particulate contaminants from LPG. The user then positions the filter in an in-line arrangement, perhaps as shown in FIGS. 1-3, and directs a flow of LPG through first filter element 42. Chemical contaminants are removed and the LPG is subsequently routed to the second filter element 48. Particulate contaminants are removed at second filter element 48 and filtered LPG is finally routed downstream of filter 2. Manipulation and placement of filter 2 within the in-line arrangement are well within the skill of a worker in this field and will therefore not be addressed further.

The present invention calls for the first and second filter elements 42, 48, to be removable for cleaning or replacement by the user at regular maintenance intervals. Such manipulations may be effectuated through the inclusion of threaded and rubber sealed attachment points between housing elements, for example, the upper housing 20 and lower housing 26 may be threaded so that they may be removably separated as shown in FIGS. 4 and 5. The general concept may be likened to that of a standard oil filter included on a gasoline engine. It is envisioned that the lower housing 26 including the first and second filter elements 42, 48 (with or without the cylinder 62), may be disposable as a unit when the respective filter elements 42, 48 are exhausted or clogged. Upper housing 20 may remain as a permanent fixture within whatever in-line arrangement the filter is being used. Lower housing 26 may be reused and the first and second filter elements 42, 48 replaced individually, or as a unit. As well, enclosure 44 of first element 42 may be reused while agent 46 is discarded and replaced with fresh agent 46, as described above. Convenient replacement of agent 46 may be facilitated where the enclosure 45 does not completely enclose agent 46 as in the embodiment shown in FIG. 5 and described in detail above. Furthermore, the replacement schedule for replacing the filter elements may be based on a known life expectancy for the respective filter elements based on use conditions (e.g., flow rate, contaminant concentrations) or, alternatively, be determined by a downstream measure of LPG quality such as that provided by sensor 56 or other suitable qualitative detector.

The usefulness of the above-described invention will now be demonstrated by way of the following informative examples. These examples are in no way meant to limit the scope of the invention and are included for illustrative purposes only.

### EXAMPLE 1

Components of residue buildup in various LPG handling equipment, including regulators and storage tanks, were identified by Fourier Transform Infrared (FT-IR) spectroscopic analysis and computer comparison to a library of known infrared spectra available as Hummel Infrared Standards from Thermo Nicolet Corp. A Nicolet 730 FT-IR spectrometer equipped with a SenSir Durascope was used to gather and analyze the spectra shown in FIGS. 7-9. The contaminants identified are presented for illustrative purposes only and are by no means the only chemical contaminants present in commercially available LPG which may result in residue buildup.

Referring to FIG. 7, the upper spectra shows infrared data obtained by swiping the residue from the interior of an LPG regulator with a methanol-coated swab and subtracting methanol background. The lower spectra shows the closest match identified by the analysis software (confidence level=77.59; scale of 0-100). The closest match is di-n-butyl amine, a small organic molecule, which is evidently a contaminant introduced in the manufacturing process of this LPG sample.

Referring to FIG. 8, the upper spectra shows infrared data obtained by sampling the residue from the inside of a storage tank. The lower spectra shows the closest match identified by the analysis software (confidence level=86.16). The closest match was di-(2-ethyl hexyl) amine, another small organic molecule believed to be introduced into the LPG in the manufacturing process.

Referring to FIG. 9, the upper spectra shows the infrared data obtained by sampling film formed on a diaphragm. The lower spectra shows the closest match identified as Dapro DF-911, an amine-based commercial product useful in defoaming and anti-filming applications (confidence level=96.37). This molecule may have been introduced into the LPG during manufacture or may have become a contaminant in subsequent handling.

### EXAMPLE 2

A study was conducted on a filter, described in detail below, to determine its usefulness in removing contaminants from LPG. A circular flow circuit was constructed wherein LPG was pumped from a bulk storage tank by a pump with a volume recording feature to the inlet of the filter. Filtered LPG then exited the filter at the outlet and proceeded in a return line to the bulk storage tank. An LPG sampling port was provided at the bulk storage tank so that samples could be withdrawn at data points corresponding to the volume of LPG pumped through the filter. The bulk storage tank contained approximately 800 gallons of LPG. With this circular pumping arrangement, the contaminant level of the LPG in the bulk storage tank was expected to be reduced in relation to the volume of LPG pumped through the filter (i.e., the larger the volume of LPG pumped through the filter, the lower the contaminant concentration of LPG in the bulk storage tank).

All filter components, except the chemical contaminant removing first filter element, were available in the form of a coalescing filter manufactured by Pall Process Filtration Co., and distributed by Enpro, Inc., Addison, Ill. under cat. no. PC401-L-G16H13. A first filter element was formed from fine brass mesh and contained 2 lbs. of zeolite, available from W. R. Grace and Co. under the tradename Formed Molecular Sieve having a porosity of approximately 10 angstroms. The coalescing filter included a second filter element having a corrugated paper filter with approximate porosity of 30 microns, available from Enpro, Inc., cat no. RGN1FN250. The flow rate of the system was maintained at approximately 10 gallons/minute.

A pre-filter sample of LPG was collected and then subsequent post-filter samples were collected at the sampling port after 10, 100, and 500 gallons of LPG had flowed through the filter. These samples were submitted for FT-IR spectroscopic analyses as described above in Example 1 and the resultant spectra are shown in FIGS. 10-13, described below.

FIG. 10 represents spectral data for the LPG sample obtained pre-filtering. The upper spectra shows the infrared data obtained for the sample after necessary subtractions and the lower two spectra show the closest matches as identified by the computer software. The matches are a base solvent (confidence=91.54) and mineral seal oil (confidence=91.48). Chemical contaminants were evident in this sample.

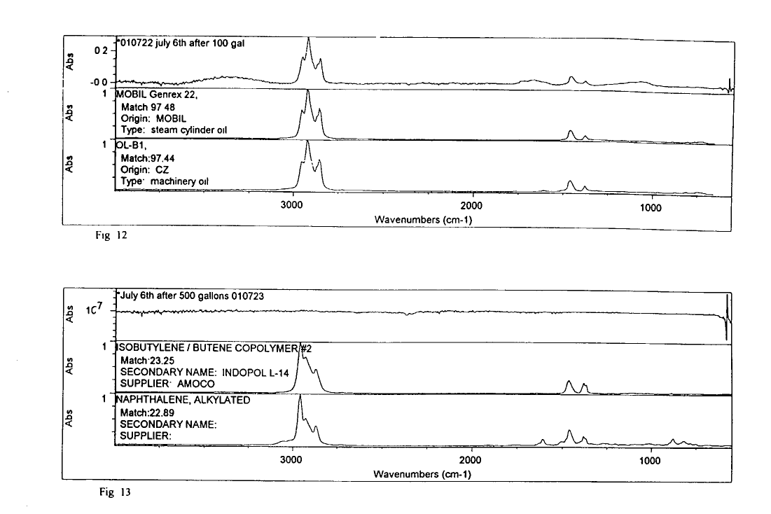

FIG. 11 shows spectral data for an LPG sample obtained after 10 gallons of LPG had been run through the filter. The upper spectra shows the infrared data obtained for the sample after necessary subtractions and the lower two spectra show the closest matches as identified by the computer software. The matches are a paraffinic base oil (confidence=93.53) and Dapro DF-900 (confidence=93.26), an amine-based defoamer. Most importantly, the absorbance for the peaks in the range of 2700-3000 cm⁻¹ wavenumbers has noticeably decreased from the pre-filter sample shown in FIG. 10.

FIG. 12 shows spectral data for an LPG sample obtained after 100 gallons of LPG have been run through the filter. The upper spectra shows the infrared data obtained for the sample after necessary subtractions and the lower two spectra show the closest matches as identifed by the computer software. The closest matches are MOBIL Genrex 22 (confidence=97.48) and OL-B1 (confidence=97.44). Again, it can be observed that the absorbance of the peaks in the range of 2700-3000 cm⁻¹ wavenumbers has noticeably decreased from the pre-filter sample shown in FIG. 10 and the sample in FIG. 12.

FIG. 13 shows spectral data for an LPG sample obtained after 500 gallons of LPG have been run through the filter. The upper spectra shows the infrared data obtained for the sample after necessary subtractions and the lower two spectra show the closest matches as identifed by the computer software. The closest matches are isobutylene/butene copolymer #2 (confidence=23.25) and alkylated naphthalene (confidence=22.89). It should be noted that the confidence levels on identifying the closest matches are now far below what is considered reliable and contaminants have apparently been effectively removed by the filter. It is further evident that the absorbance peaks in the range of 2700-3000 cm⁻¹ wavenumbers have decreased to the point where the concentration of contaminating compounds has decreased to the point of being negligible, or at least all but undetectable by the detection techniques used here.

While the invention has been described with reference to preferred embodiments, those skilled in the art will appreciate that certain substitutions, alterations, and omissions may be made without departing from the spirit of the invention. Accordingly, the foregoing description is meant to be exemplary only and should not limit the scope of the invention set forth in the following claims.

What is claimed is:

1. A filter for removing contaminants from liquid propane gas, comprising:
an upper housing including an inlet capable of receiving liquid propane gas from upstream of the filter and an outlet capable of conveying liquid propane gas downstream of the filter;
a lower housing removably attached to the upper housing and communicating with the inlet;
an inner assembly having first and second ends, said inner assembly removably attached to the upper housing and communicating at said first end with the outlet, the inner assembly being disposed within and spaced apart from the outer housing thusly defining a first filtration zone, the inner assembly itself further defining a second filtration zone;
a first filter element removably positioned between the outer housing and the inner assembly in the first filtration zone, the first filter element comprised by a liquid propane gas permeable enclosure enclosing a molecular sieving agent; and
a second filter element removably contained within the second filtration zone and comprised by a porous filtration material wherein the first and second filter elements communicate with each other at a boundary between the first and second filtration zones.

2. A filter according to claim 1 wherein the filter further includes a sensor in communication with the liquid propane gas at the outlet for indicating the flow rate, the volume filtered, the contaminant level, or any combination thereof for liquid propane gas exiting the filter.

3. A filter according to claim 1 wherein the inner assembly includes a cylinder at the boundary between the first and second filtration zones, said cylinder partially enclosing the second filter element and having a plurality of perforations allowing flow of liquid propane gas between the first and second filtration zones.

4. A filter according to claim 1 wherein the liquid propane gas permeable enclosure is formed from a material selected from the group consisting of paper, cardboard, fabric, plastic and metallic mesh.

5. A filter according to claim 1 wherein the liquid propane gas permeable enclosure is comprised by a metallic mesh.

6. A filter according to claim 1 wherein the liquid propane gas permeable enclosure completely encloses the molecular sieving agent.

7. A filter according to claim 6 wherein the liquid propane gas permeable enclosure is formed from a metallic mesh.

8. A filter according to claim 7 wherein the molecular sieving agent is selected from the group consisting of crystalline aluminosilicates, crystalline aluminum-magnesium silicates, crystalline aluminophosphates, activated carbons and charcoals.

9. A filter according to claim 1 wherein the liquid propane gas permeable enclosure does not completely enclose the molecular sieving agent.

10. A filter according to claim 9 wherein the liquid propane gas permeable enclosure is formed from a metallic mesh.

11. A filter according to claim 10 wherein the molecular sieving agent is selected from the group consisting of crystalline aluminosilicates, crystalline aluminum-magnesium silicates, crystalline aluminophosphates, activated carbons and charcoals.

12. A filter according to claim 1 wherein the molecular sieving agent is selected from the group consisting of crystalline aluminosilicates, crystalline aluminum-magnesium silicates, crystalline aluminophosphates, activated carbons and charcoals.

13. A filter according to claim 1 wherein the molecular sieving agent is a zeolite having a porosity in the range of about 2 angstroms to about 100 angstroms.

14. A filter according to claim 1 wherein the molecular sieving agent is a zeolite having a porosity in the range of about 4 angstroms to about 20 angstroms.

15. A filter according to claim 1 wherein the molecular sieving agent is a zeolite having a porosity of about 10 angstroms.

16. A filter according to claim 1 wherein the porous filtration material of the second filter element has a porosity in the range of about 5 to about 50 microns.

17. A filter for removing contaminants from liquid propane gas, comprising:
an inlet for receiving liquid propane gas from an upstream source;
a first filter element in communication with the inlet for removing chemical contaminants from the liquid propane gas;
a second filter element for subsequently removing particulate contaminants from the liquid propane gas; and
an outlet for conveying the liquid propane gas beyond the second filter element.

18. A filter according to claim 17 further including a sensor for indicating the contaminant level of liquid propane gas exiting the filter, the liquid propane gas flow rate, the volume filtered, or any combination thereof.

19. A filter according to claim 17 wherein the first filter element includes a liquid propane gas permeable enclosure completely enclosing a molecular sieving agent.

20. A filter according to claim 17 wherein the first filter element includes a liquid propane gas permeable enclosure incompletely enclosing a molecular sieving agent.

21. A filter according to claim 20 wherein the molecular sieving agent is selected from the group consisting of crystalline aluminosilicates, crystalline aluminum-magnesium silicates, crystalline aluminophosphates, activated carbons and charcoals.

22. A method for removing contaminants from liquid propane gas, comprising the steps of:
routing a flow of liquid propane gas through a molecular sieving agent contained within a first filter element, thereby initially removing chemical contaminants from the liquid propane gas; and
subsequently routing the flow of liquid propane gas through a second filter element, thereby removing particulate contaminants from the liquid propane gas.

23. A method according to claim 22 wherein the molecular sieving agent is selected from the group consisting of crystalline aluminosilicates, crystalline aluminum-magnesium silicates, crystalline aluminophosphates, activated carbons and charcoals.

24. A method according to claim 22 wherein the molecular sieving agent is a zeolite having a porosity in the range of about 2 angstroms to about 100 angstroms.

25. A method according to claim 22 wherein the first filter element further comprises a removable liquid propane gas permeable enclosure, said enclosure completely surrounding the molecular sieving agent.

26. A method according to claim 22 wherein the first filter element further comprises a removable liquid propane gas permeable enclosure, said enclosure partially surrounding the molecular sieving agent.

27. A method according to claim 22 wherein the second filter element has a porosity in the range of about 5 to about 50 microns.

28. A method according to claim 22 further comprising the step of monitoring the liquid propane gas exiting the filter to determine the level of contaminants remaining in the liquid propane gas, the liquid propane gas flow rate, the volume filtered, or any combination thereof.

29. A method according to claim 22 wherein the first filter element and the second filter element are separated by a cylinder, said cylinder partially enclosing the second filter element and having a plurality of perforations allowing flow of liquid propane gas between the first and second filter elements.

30. A filter for removing contaminants from liquid propane gas, comprising:
an inlet for receiving liquid propane gas from an upstream source;
a molecular sieving agent in communication with the inlet for removing chemical contaminants from the liquid propane gas, constituting a first filter element;
a second filter element for subsequently removing particulate contaminants from the liquid propane gas; and
an outlet for conveying the liquid propane gas beyond the second filter element.

31. A filter according to claim 30 further including a sensor for indicating the contaminant level of liquid propane gas exiting the filter, the liquid propane gas flow rate, the volume filtered, or any combination thereof.

32. A filter according to claim 30 wherein the molecular sieving agent is selected from the group consisting of crystalline aluminosilicates, crystalline aluminum-magnesium silicates, crystalline aluminophosphates, activated carbons and charcoals.
